(19) United States
(12) Patent Application Publication
(10) Pub. No.: US 2025/0306913 A1
(43) Pub. Date: Oct. 2, 2025

(54) KNOWN VERSION PATCHING

(71) Applicant: ELECTRONIC ARTS INC., Redwood City, CA (US)

(72) Inventor: Hendrikus Lambertus Johannes van Veenendaal, Vancouver (CA)

(21) Appl. No.: 18/620,043

(22) Filed: Mar. 28, 2024

(51) Int. Cl. G06F 8/658; A63F 13/77

(52) U.S. Cl. CPC G06F 8/658; A63F 13/77

(57) ABSTRACT

Systems and methods are provided for performing patch calculation and block scanning both a current/existing build and a target build at a server or other location that is remote from a client computing device, where patch calculations/generation is conventionally performed. Patch calculation may be performed using scan block sizes that are smaller than what is conventionally used, and is not limited files (source/target) having the same name. Additionally, adjacent blocks of data representative of binary resources may be concatenated, and block edges can be scanned to determine if still other data/resources could be used for the target build.

### CROSS-REFERENCE TO RELATED APPLICATION

This application is related to co-pending and co-owned US Patent Publication No. 2020/0310777, entitled “Efficient Binary Resource Distribution to Client Computing Devices,” which is incorporated herein by reference in its entirety.

### TECHNICAL FIELD

The present disclosure is generally related to content delivery networks (CDNs), and more particularly related to server-side systems and methods of software patching, where a determination can be made regarding what portions of existing files can be used to form a patch plan.

### BACKGROUND

Software products may be distributed, in the form of one or more files, to multiple client computing devices via a CDN. Each of the files may store one or more binary resources, such as executable code files, data files, graphic assets (e.g., textures, still images, fonts, animated images, video streams), multimedia assets, sound streams, etc. Examples of software products include interactive videogames, e-commerce applications, and various other business and/or entertainment applications.

### SUMMARY

In accordance with one embodiment, a system may comprise a processor, and a memory-readable storage medium storing instructions that when executed, cause the processor to identify reusable resources of a current software build for a target software build, and concatenate adjacent blocks representative of the identified reusable resources for use in the target software build. The instructions, when executed also cause the processor to identify additional resources for the target software build based on edges of the identified reusable resources, identify downloadable resources for the target software build, and create a patch plan in accordance with the identified reusable resources, and the downloadable resources.

In some embodiments, the instructions that cause the processor to identify reusable resources comprise further instructions that when executed, cause the processor to generate target software build artifacts. In some embodiments, the target software build artifacts comprise target software build file metadata and instructions to scan the target software build in accordance with a determined block size.

In some embodiments, the instructions that cause the processor to identify reusable resources comprise further instructions that when executed, cause the processor to calculate hash values for blocks of the target software build. In some embodiments, the calculated hash values comprise scan hash values to achieve an initial identification of reusable resources, and cryptographic hash values to validate the initial identification of the reusable resources.

In some embodiments, the instructions that cause the processor to identify reusable resources comprise further instructions that when executed, cause the processor to perform a scan of the current software build in accordance with the determined block size. In some embodiments, the instructions that cause the processor to identify reusable resources comprise further instructions that when executed, cause the processor to identify those blocks of the current software build with that of blocks of the target software build.

In some embodiments, the instructions that cause the processor to concatenate adjacent blocks representative of the identified reusable resources comprises further instructions that when executed, cause the processor to determine locations of the identified blocks in response to identifying those blocks of the current software build with a scan hash value that matches that of blocks of the target software build. In some embodiments, the instructions that cause the processor to concatenate adjacent blocks representative of the identified reusable resources comprises further instructions that when executed, cause the processor to determine adjacency of the identified blocks. In some embodiments, the instructions that cause the processor to determine adjacency of the identified blocks comprises further instructions that when executed, cause the processor to determine offsets corresponding to the identified blocks and sizes of blocks. In some embodiments, the instructions that cause the processor to determine adjacency of the identified blocks comprises further instructions that when executed, cause the processor to record the locations of the identified blocks in a copy operation array, wherein the adjacent identified blocks are to be copied in a single copy operation.

In some embodiments, the instructions that cause the processor to identify additional resources for the target build comprises further instructions that when executed, cause the processor to determine if a gap indicative of a portion of a build without a reusable resource exists at each edge of a reusable block. In some embodiments, the instructions that cause the processor to identify additional resources for the target build comprises further instructions that when executed, cause the processor to compare actual data of the current software build at the gap with actual data of the target software build. In some embodiments, the instructions that cause the processor to identify additional resources for the target build comprises further instructions that when executed, cause the processor to identify instances where the actual data of the current software build that corresponds to the gap matches that of the target software build. In some embodiments, the instructions that cause the processor to identify additional resources for the target build comprises further instructions that when executed, cause the processor to append resources associated with the identified instances to a corresponding reusable block.

In some embodiments, the instructions that cause the processor create the patch plan comprises further instructions that when executed, cause the processor to concatenate bits representative of the downloadable resources to be downloaded into a patch stream pursuant to a deduplication operation.

In accordance with some embodiments, a version patching server comprises a processor, and a memory comprising instructions that when executed cause the processor to: monitor a game development system for a software changed event associated with a new software build for upgrading a current software build. The new software build has been generated via block scanning, in accordance with a defined block size, of the new software build and the current software build at the version patching server. Moreover, the processor is caused to identify reusable resources from the current software build. In response to discovering a software changed event, a client computing device is instructed to download the new software build and a corresponding patch plan providing instructions regarding how the client computing device is to recreate the new software build based on an instance of the current software build resident on the client computing device.

In some embodiments, the defined block size comprises a configurable patching parameter selected to optimize the identification of the reusable resources.

In some embodiments, the current software build comprises a plurality of software files from which the reusable resources are identified. The plurality of software files need not be named the same as a plurality of software files comprising the new software build.

In some embodiments, the patch plan comprises a patch stream directing the client computing device to a uniform resource locator for accessing a concatenated set of downloadable, un-reusable resources, and wherein the patch plan comprises at least one set of concatenated, reusable resources.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example content delivery network (CDN) in which embodiments of the disclosed technology may be implemented.

FIG. 2 is an example computing component that may be used to create a patch plan in accordance with an embodiment of the disclosed technology.

FIG. 3 is an example computing component that may be used to identify reusable resources of a current build in accordance with an embodiment of the disclosed technology.

FIG. 4 illustrates an example scanning operation to identify reusable resources in accordance with instructions executed by the example computing component of FIG. 3.

FIG. 5 is an example computing component that may be used to determine adjacent block concatenation in accordance with an embodiment of the disclosed technology.

FIG. 6 illustrates an example adjacent block concatenation operation in accordance with instructions executed by the example computing component of FIG. 5.

FIG. 7 is an example computing component that may be used to identify additional target build resources in accordance with an embodiment of the disclosed technology.

FIG. 8 illustrates an example edge-scanning operation to identify additional target build resources in accordance with instructions executed by the example computing component of FIG. 7.

FIG. 9 is an example computing component that may be used to create a patch plan in accordance with an embodiment of the disclosed technology.

FIG. 10 illustrates an example representation of data/information comprising a patch plan created in accordance with instructions executed by the example computing component of FIG. 9.

FIG. 11 illustrates an example deduplication/copying operation in accordance with an embodiment of the disclosed technology.

FIG. 12 illustrates an example flow chart and system architecture for implementing known version patching in accordance with an embodiment of the disclosed technology.

FIG. 13 is an example computing component that may be used to implement various features of embodiments described in the present disclosure.

The figures are not exhaustive and do not limit the present disclosure to the precise form disclosed.

### DETAILED DESCRIPTION

As noted above, software products can be distributed in the form of one or more files to client computing devices, such as gaming systems, via a CDN. Each of the one or more files may comprise or store therein, one or more binary resources (or simply, resources), such as executable code files, graphic assets, etc.

A software product's lifecycle may include multiple versions. To keep a software product up-to-date, that software product may be upgraded from a current or existing build level (or “version”) to a subsequent/target build level or version. Such a version upgrade typically involves updating the binary resources stored by the CDN. For example, each client computing device that has the software product may perform updates of those client computing device's locally stored binary files forming a current build of the software product. In this way, a software product (locally-installed on a client computing device) can be built to the new version available from the CDN.

Since a typical software product update modifies a subset of the installed binary resources and/or introduces new binary resources, while re-using at least some portion of the installed binary resources, such incremental updates involve file “patching,” e.g., partially overwriting locally stored files with the content downloaded from a CDN in the form of fixed or variable size blocks. Various patching techniques attempt to identify reusable portions of the locally-installed software product build that may be utilized by the upgraded build. In certain implementations, the patching process involves identifying matching blocks of a determined size in the existing build and the new build, thus only downloading new or modified blocks.

However, version patching is generally performed at a client computing device, which can be time-consuming, e.g., a user may wait several minutes before the downloading of actual patch data commences. For example, conventional patching techniques typically determine what to download by looking, at a time of update, what software (e.g., game) a client computing device is currently running/has stored thereon, irrespective of version or other identifying information in/associated with software. This process occurs for every user/client computing device for which an update is needed. Because such conventional methods are premised on scanning files and attempting to identify blocks in those files, the scanning process cannot be offloaded, from the client computing device, to any computing entity, such as a server. Moreover, conventional patching techniques or mechanisms generally rely on determined block sizes that are large relative to the size of the binary resources in the software product. This has the effect of patch files (or simply patches) being larger than necessary, e.g., if a block encompasses a plurality of binary resources, when any one of those binary resources is changed, or an order of a binary resource changes in a particular software product file, the entire block will be marked for downloading. Furthermore, conventional patching systems typically only perform patching between files having the same file name. Thus, if a software product build reorganizes a build, large patches can result. Additionally still, conventional patching techniques may involve the use of many calls to obtain portions or aspects of a synchronization package (i.e., an uncompressed version of a build (e.g., a game build) that includes some additional block hash metadata). These calls increase latency/incur processing costs, which can be problematic in a latency-sensitive CDN.

Thus, embodiments of the disclosed technology are directed to performing patch calculation and block scanning both a current/existing build and a target build at a server or other location (e.g., a server of the CDN) that is remote from the client computing device. In this way, version patching delays or latency at a client computing device can be avoided. Additionally, at a server/at the CDN, both source and target data are simultaneously available. In contrast to the aforementioned conventional patching techniques, embodiments of the disclosed technology, as described herein, may utilize software/application version information that is embedded in the software, allowing for the scanning to occur off/away from a client computing device. The patch calculation described herein need only be performed once to create a source (current)-to-target version at the server side at the time of deployment to the CDN.

Moreover, embodiments of the disclosed technology execute patch calculation using scan block sizes that are smaller than what is conventionally used. As noted above, conventional block sizes for scanning are typically larger, e.g., 64K bytes, which can lead to unnecessarily large patches. Conventional wisdom suggests a preference for larger block sizes when calculating patches on a client computing device because the larger block sizes tend to reduce the amount of metadata to be downloaded to identify resource matches. By conducting the scanning procedure in accordance with smaller block sizes, e.g., on the order of approximately, 4K bytes, such issues can be mitigated or avoided altogether. This is made possible, in part, by performing the patch calculation away from the client computing device, e.g., at a server of the CDN. It should be understood that block size is a configurable parameter, and in principal, can be whatever is desired. However, typically a balance is sought, whereby reducing the block size equates to very large patch plans (many calls for smaller resources), whereas increasing the block size equates to scenarios where so many resources are considered together that reusable resources from software on a client computing device would be difficult to identify. For example, varying block size based on file type would make scanning an entire software update more complicated/prevent certain matches regarding reusable resources.

To improve upon conventional patching methods that are limited to same-name files, embodiments of the disclosed technology allow for scanning multiple files, e.g., all files of software/software package. In this way, the scanning process may find binary resources that have moved between files, e.g., in a previous version, the resource may be located/referenced in a first location, and in a subsequent, e.g., target, version, the resource may have moved to a second location/referenced in a second location.

Further still, embodiments of the disclosed technology allow for concatenating blocks that are adjacent to one another, and further scanning resource block edges to determine if still other data/resources could be used for the target build. Upon completion of block/edge scanning and concatenation, information regarding any bits belonging to scanned blocks that are to be moved, e.g., due to concatenation, as well as any bits that are to be downloaded can be incorporated into a patch plan. The patch plan can be transmitted to a client computing device, and the client computing device can execute the patch plan to carry out any bit rearrangement and bit downloading, and ultimately, recreate the target file at the client computing device prior to deleting any “old” source files, current files that will no longer be valid/used after the target version/files are recreated and executed.

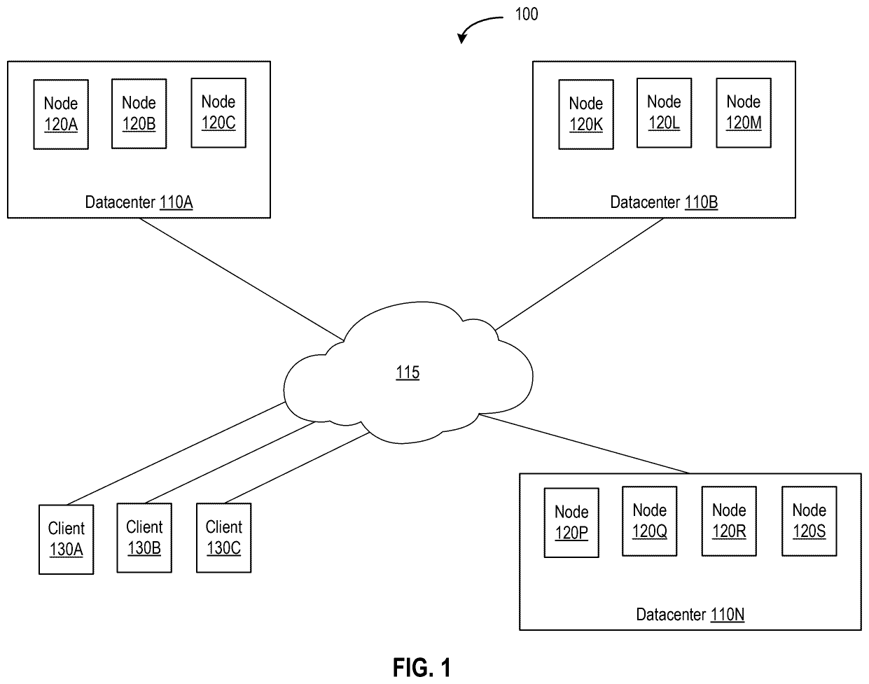

FIG. 1 is a schematic representation of a high-level, example CDN 100 operating in accordance with one or more aspects of the present disclosure. Computing devices, appliances, and network segments are shown in FIG. 1 for illustrative purposes only, and do not in any way limit the scope of the present disclosure. Various other computing devices, components, and appliances, and the like not shown in FIG. 1, and/or methods of their interconnection may be compatible with the methods and systems described herein. Various functional or auxiliary network components (e.g., firewalls, load balancers, network switches, user directories, content repositories, etc.) may be omitted from FIG. 1 for clarity.

In the example of FIG. 1, the CDN 100 may include content delivery nodes 120A-120S residing in multiple datacenters 110A-110N interconnected by one or more networks 115. In the example of FIG. 1, each cluster of content delivery nodes 120A-120S located in a datacenters 110A-110N collectively stores the full set of distribution files forming a current build of a software product to be distributed to the client computing devices 130A-130C.

The datacenters 110A-110N may be geographically distributed in order to increase the overall throughput and reduce the network-related latency in servicing the client requests, e.g., by redirecting each request to a datacenter which is located in a geographic proximity to the request-originating client. The CDN 100 may implement various load balancing mechanisms, cache coherence protocols and strategies, and/or other techniques aimed at improving the efficiency of the content distribution.

Distribution of binary resources to client computing devices 130A-130C may involve receiving, by each of client computing devices 130A-130C, build metadata utilized for creating a patch plan. Distribution may further involve creating a directory structure for the new build, creating empty files (e.g., with a predetermined filename extension, such as .patch) in the directory structure, and executing the patch plan that specifies a sequence of operations to be performed by the client computing device in order to upgrade a locally installed software product from the current build to the new build level matching the latest build level available from the CDN. In certain implementations, executing the patch plan may involve moving resources from the current build into the new build locations within the created directory structure, downloading the missing resource data, copying at least some of the resources into secondary locations thus creating multiple instances of such resources in the new build, and renaming the patched files, and described in greater detail below.

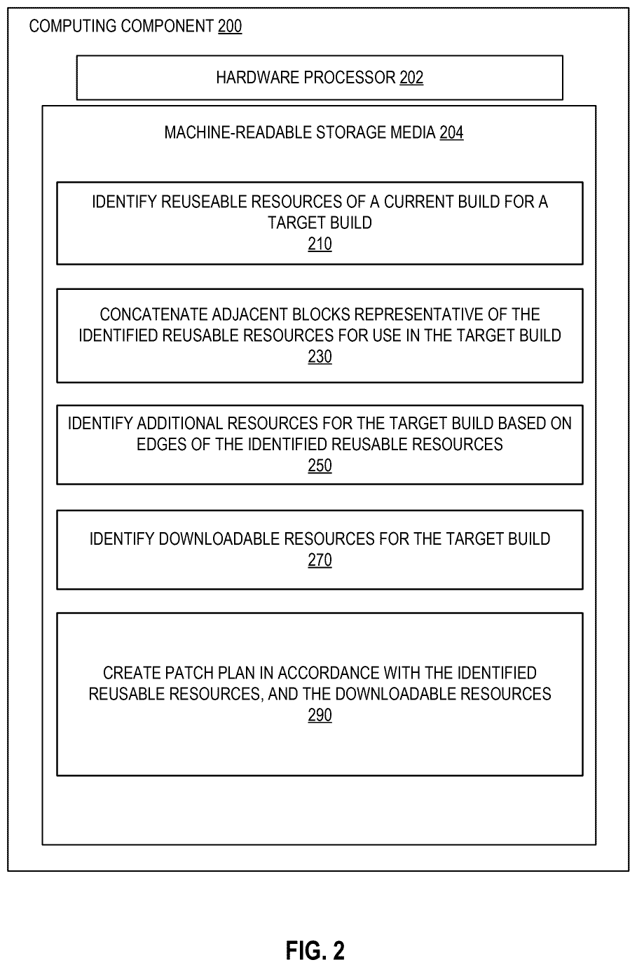

FIG. 2 illustrates an example computing component 200 that may be used to implement the creation of a patch plan in accordance with various embodiments of the disclosed technology to achieve known version patching. Referring now to FIG. 2, computing component 200 may be, for example, a server computer, a controller, or any other similar computing component capable of processing data, e.g., at/in a CDN. In the example implementation of FIG. 2, the computing component 200 includes a hardware processor 202, and machine-readable storage medium 204.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 210-290, to control processes or operations for creating a patch plan in accordance with known version patching systems and methods disclosed herein. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 210-290.

Hardware processor 202 may execute instruction 210 to identify reusable resources of a current build for a target build. In some embodiments, a target build may comprise binary resources, and build metadata can, for each resource, specify a file in which the resource is stored, a resource offset within the file, the resource's size, and a hash(es) corresponding to the resource. As will be described in greater detail below, current build resources may be compared to target build resources. The comparison, performed using hash scans and a desired scan block size, identifies those resources in a current build that can be reused in the target build. As discussed above, embodiments of the disclosed technology are implemented at a server or other computing component/element that is not a client computing device. Again, performing patching operations, such as determining reusable resources takes time when performed locally/at a client computing device (waiting, e.g., several minutes before the downloading of actual patch data occurs). Moreover, scanning the current/target builds with smaller scan block sizes in accordance with embodiments of the disclosed technology, providing for more “accurate” determinations. That is, when scan block sizes are too large, as is the case with conventional implementations of patching, blocks corresponding to resources to be downloaded include data that need not be downloaded.

Hardware processor 202 may execute instruction 230 to concatenate adjacent blocks representative of the identified reusable resources for use in the target build. Concatenation (or merging) as referred to herein may comprise an operation(s) used to reduce the number of operations, e.g., copy operations, to copy a given range of bytes. The given range of bytes may correspond to a block(s) or a portion(s) of blocks of data representative of reusable binary resources, as will be described below. That is, adjacent blocks of data can be copied as a single, concatenated block, instead of copying two separate blocks of data using two, distinct copy operations.

Hardware processor 202 may execute instruction 250 to identify additional resources for the target build based on edges of the identified reusable resources. That is, after concatenating resources associated/represented by adjacent blocks in the target build, subsequent scanning of the edges/boundaries about the concatenated resources/resource blocks may be performed. For example, gaps in/adjacent to concatenated resource blocks, e.g., block edges, can be identified in the target build, and a re-scanning of the current build can be performed to determine if any additional resources may be reused. Such additional resources, if they exist, may be concatenated with a corresponding block to “grow” that block.

Hardware processor 202 may execute instruction 270 to identify downloadable resources for the target build. That is, any remaining blocks that have no “equivalent” source data (from the current build) will need to be downloaded from the CDN.

Hardware processor 202 may execute instruction 290 to create a patch plan in accordance with the identified reusable resources, and the downloadable resources. For example, bits corresponding to blocks of resources to be moved and/or bits to be downloaded are recorded. The bits to be downloaded may also be concatenated into a patch stream. It should be noted that some builds, e.g., for games, comprise builds for different languages that a game may support. That is, resources that are associated with/correspond to different languages, typically will not be patched together. Rather, the execution of the aforementioned instructions accounts for each language separately, where separate language streams are generated.

In some embodiments, a deduplication process may be performed. That is, and as noted above, all bits to be downloaded can be concatenated into a patch stream. When generating hash tables to map scan hash values to target block locations (described below), the server will know/can determine or identify whether a block(s) is used in multiple locations in a target file. When creating a patch plan, a first instance of a block to be downloaded is downloaded, and then copied to other location instances.

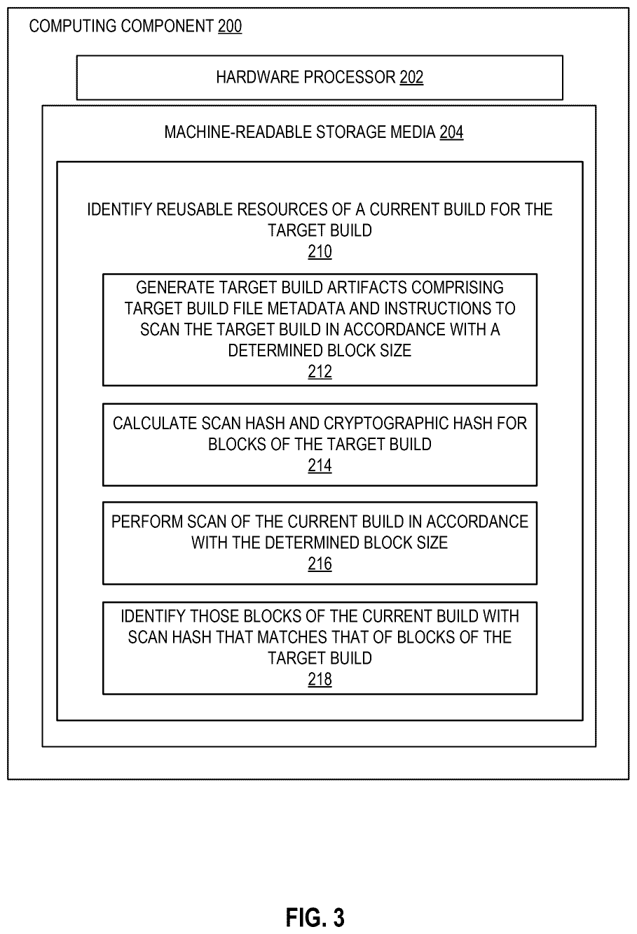

FIG. 3 illustrates the example computing component 200 (FIG. 2) that may be used to identify reusable resources of a current build for the target build. Computing component 200, hardware processor 202, and machine-readable storage media 204 have been described/discussed above.

Hardware processor 202 may execute instruction 212 to generate target build artifacts comprising target build file metadata and instructions to scan the target build in accordance with a determined block size. For example, an “installer” artifact comprising a file may be generated, where the installer artifact file may contain metadata regarding the file(s) in a build, such as a game build. The metadata may include, but is not limited to, e.g., filename, file size, file hash (over a whole file for verification), a file data and any relevant locates (all languages to which a file belongs). If the locales metadata does not exist, the file is language agnostic.

Hardware processor 202 may execute instruction 214 to calculate scan and cryptographic hashes for blocks of the target build. Accordingly, another artifact, referred to as a blockinfo artifact, may be generated regarding hash information for each file in a build. Such an artifact may comprise a metadata file containing, e.g., block size information, hash algorithm (identification) information, and the block hashes of the target build file(s). Each block hash may comprise a scan hash, such as a Rabin Karp scan hash, and a cryptographic has, such as an MD5 or SHA1 has for match validation. It should noted that typically, a scan hash can be performed quickly, but may lead to false matches, whereas a cryptographic hash (and a corresponding cryptographic hash check) can ensure or validate that a block identified as a match with the scan hash, can be confirmed by the cryptographic hash.

Based on the blockinfo artifact metadata, hash tables are generated for each language and language-agnostic files of the target build. These hash tables comprise hash maps that associate scan hash information of the target build with blockinfo artifact data. That is, the hash maps can be loaded with the blockinfo data regarding the target build. All language-agnostic file data can be loaded in a “no languages” hash table, and all language-specific files data can be input into corresponding language hash tables In this way, a mapping can be created between scan hash data and block locations in target build files.

Hardware processor 202 may execute instruction 216 to perform a scan of the current build in accordance with the determined block size. That is, the file(s) of a current build may be scanned with a scanning window having the determined block size. As mentioned above, a typical block size is larger than a block size contemplated for use in accordance with various embodiments of the disclosed technology. For example, a typical block size used for scanning is 64K, whereas smaller block sizes are contemplated in accordance with embodiments of the disclosed technology, e.g., on the order of 4K.

Hardware processor 202 may execute instruction 218 to identify those blocks of the current build with a scan hash value that matches the scan hash of blocks of the target build. As noted above, for each file in a target build, a blockinfo artifact is generated, where the blockinfo artifact comprises, in part, scan hash data for quick matching. If a match(es) are discovered/identified, a cryptographic hash may be calculated to verify/confirm the scan hash-based match. If a match(es) exist, the source file location corresponding to such matching block(s) is recorded into a copy operation array. In this way, a block array exists for each target build file(s) that indicates in what source file, and at what offset a block that matches the target block may be found.

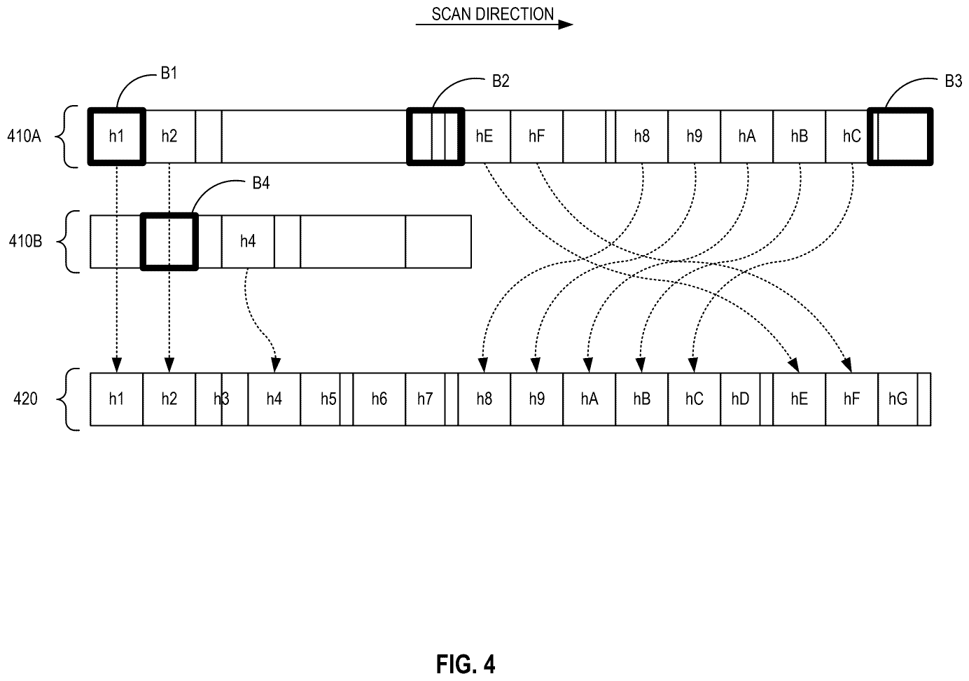

FIG. 4 illustrates an example scanning operation to identify reusable resources in accordance with an embodiment of the disclosed technology. FIG. 4 illustrates an example scanning scenario, where two source files (410A, 410B) exist for a current build. Source files 410A and 410B may be scanned to identify any resource matches with a target file of a target build. The number of source/target files that make up a current/target build, respectively, may vary. Scanning may comprise iterating through blocks of a defined size of a file(s) of a current or target build.

The windowed scan of source files 410A and 410B is as follows. In the scan direction, it can be appreciated that the resources in source file 410A of a current build having the following hash values match those of target file 420 of a target build (and thus can be reused): h1, h2, h89, h9, hA, hB, hC, hE, and hF. Regarding source file 410B of the current build, a resource block with a hash value h4 of source file 410B matches a resource of target file 420 of the target build. Block windows B1, B2, B3, and B4 illustrate how reduced size results in most scanned blocks being singular blocks, with few scans spanning multiple blocks (avoiding certain aforementioned disadvantages of conventionally-implemented version patching). In other words, and as discussed above, smaller block sizes aid in the identification of more binary resource matches between source and target versions of software, because the use of larger blocks may result in identifying matching blocks, but the corresponding resources may not match. Moreover, smaller block sizes tend to reduce the identification of un-matchable blocks at resource boundaries if the resource ordering isn't the same in a source file as it is in a target file, or between differently-named files. The “growing” of blocks, e.g., identifying additional reusable resources at block edges effectively eliminates most losses in these areas/in such scenarios.

It should be noted that any differences between the order and/or offsets of resources between source and target files does not impact the determination of resource matches. Again, embodiments of the disclosed technology rely on hash values provided by build data. For example, it can be appreciated that the order of matching resources h8, h9, and hA-hF differs between source fille 410A and target file 420.

It should also be noted, in accordance with various embodiments of the disclosed technology, that patching need not be limited to files with the same name. Indeed, it can be appreciated that the scanning process disclosed herein may encompass multiple files that may not have the same name. For example, the example scanning operation illustrated in FIG. 4 reflects that matching resources may be identified from two source files, i.e., source files 410A and 410B.

Any remaining resources of the target build (i.e., resources of the target build for which corresponding resources of the current build do not exist or cannot be reused without at least some modifications due to the hash mismatch, e.g., such as resources h5, h6, h7, hD, and hG) may be downloaded from the CDN. Alternatively, block scanning may be performed again in order to identify any blocks which can be reused for the new or modified resources.

Accordingly, an identified resource block of a current build may be copied, from a current build file in accordance with any offset within a current build file specified by current build metadata, to the new build file and in accordance with any offset within a target build file specified by target build metadata.

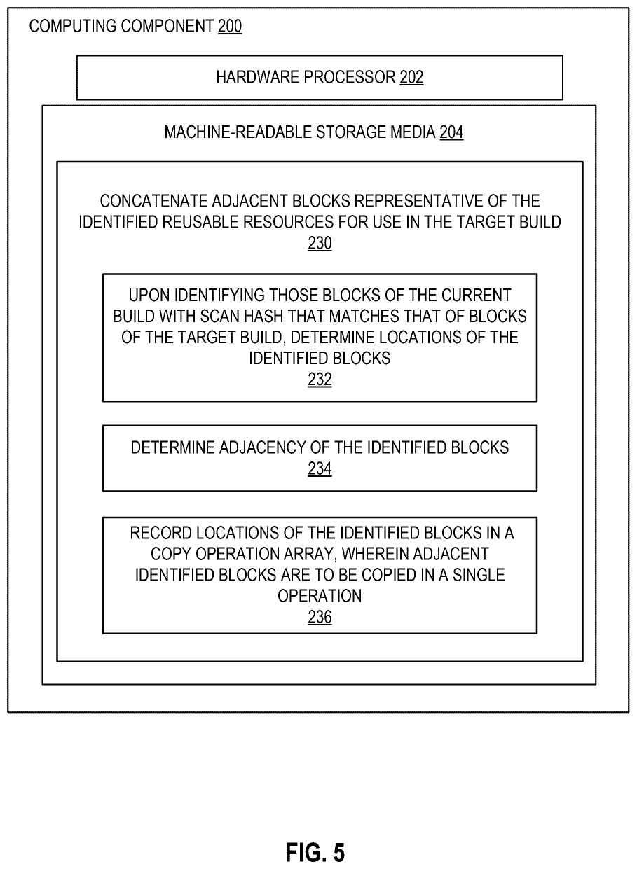

FIG. 5 illustrates an example computing component that may be used to determine adjacent block concatenation in accordance with an embodiment of the disclosed technology. Computing component 200, hardware processor 202, and machine-readable storage media 204 have been described/discussed above.

Hardware processor 202 may execute instruction 232 to, upon identifying those blocks of the current build with a scan hash value that matches that of blocks of the target build, determine locations of the identified blocks. As noted above, copying source file location information of a matching block into such an array provides the requisite information/knowledge regarding where a target build-matching block can be found in a current build file. This includes (location) offset information, that with information regarding the size of the data to be copied/reused in a target file(s) can be used ton concatenate or merge blocks of data.

Hardware processor 202 may execute instruction 234 to determine aadjacency of the identified blocks. As discussed herein, adjacent blocks of data may be concatenated for copying/reuse purposes because they can be “merged” and copied as one block of data. Adjacency can be determined based on whether the offset of a second copy operation is the same as the offset (plus the size of the data) of the previous/preceding copy operation for both source and target file/version offsets. That is, the “previous” copy operation may be for a first block with a particular offset, and the “second” copy operation would be for the second block. If the offset/size is as noted above, the blocks are adjacent and can be copied in a single copy operation/copied at once as a merged block.

Hardware processor 202 may execute instruction 236 to record the locations of the identified blocks in a copy operation array, where adjacent identified blocks are to be copied in a single copy operation. In other words, two or more adjacent blocks, instead of invoking/effectuating two or more corresponding copy operations (commensurate with the number of blocks to be copied), the adjacent blocks can be copied in/with a single copy operation.

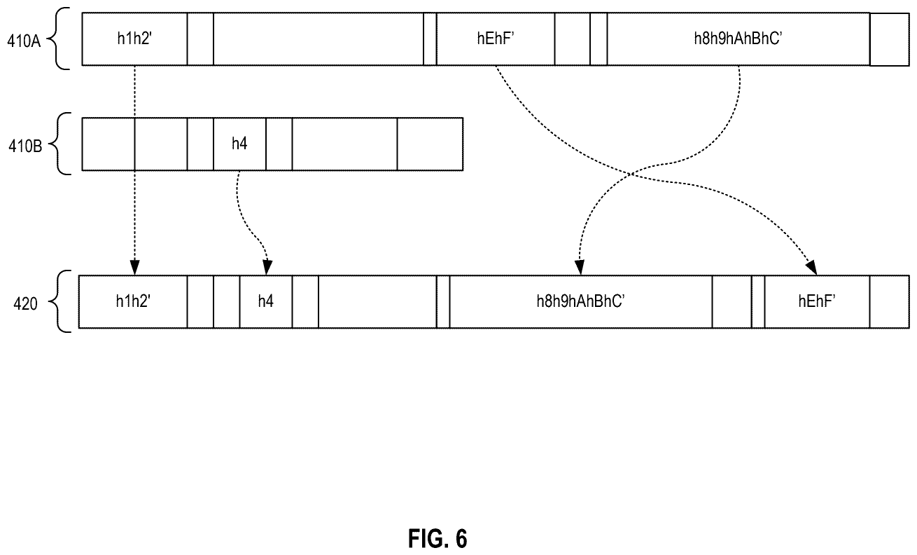

FIG. 6 illustrates the result of concatenation at source files 410A/410B of the current build, and target file 420 of the target build. It can be appreciated that what was once two resource blocks (represented by hash values h1 and h2) have been merged into a single resource h1h2′. Similarly, the resource blocks associated with hash values hE and hF are determined to be adjacent, and thus, are concatenated resulting in merged resource block hEhF′. The same holds true of adjacent resource blocks with the hash values h8, h9, hA, hB, and hC, which when merged, results in a concatenated resource block referred to as h8h9hAhBhC′. It should be noted that the merged/concatenated block resources are referred to by their corresponding hash values for ease of reference. As noted above, concatenation comprises grouping multiple blocks of data for copying/downloading purposes. For example, concatenation of blocks h1 and h2 may comprise determining the respective locations, e.g., per offset values, of blocks h1 and h2. In accordance with conventional patching techniques, blocks h1 and h2, after being identified as reusable in a target file, would be downloaded separately, as block h1, and as block h2. In contrast, concatenating adjacent blocks in accordance with various embodiments, results in a single copy operation that copies both h1 and h2 blocks.

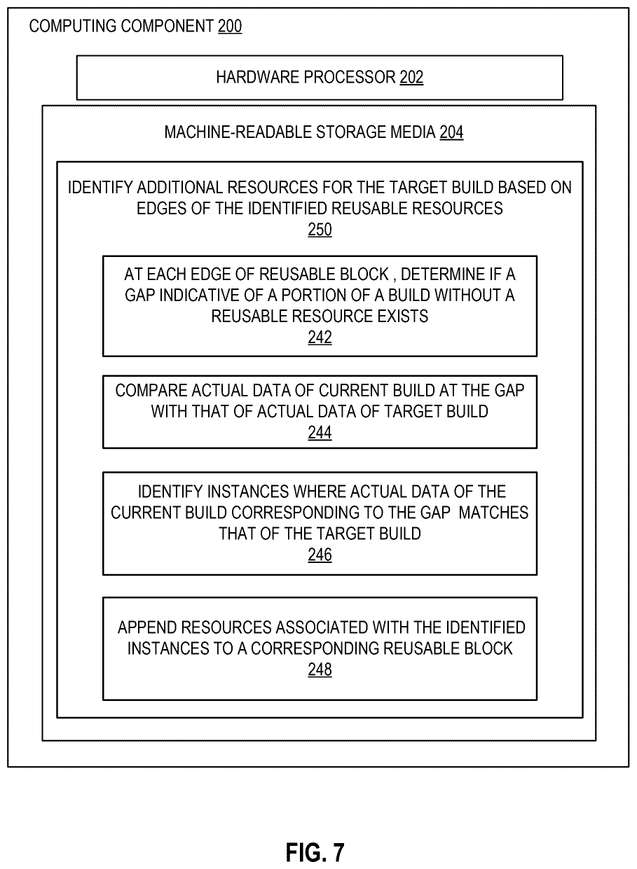

FIG. 7 illustrates an example computing component that may be used to identify additional target build resources in accordance with an embodiment of the disclosed technology. Computing component 200, hardware processor 202, and machine-readable storage media 204 have been described above.

Hardware processor 202 may execute instruction 242 to, at each edge of a reusable block, determine if a gap indicative of a portion of a build without a reusable resource exists. That is, scenarios can arise where, due to the scanning process per the determined block size, certain portions of a binary resource may not be “captured.”

Hardware processor 202 may execute instruction 244 to compare actual data of a current build at the gap with actual data of a target build. In accordance with some embodiments, rather than perform another hash scan, actual data between current and target builds may be compared. As mentioned above, certain portions of a binary resource may not be captured. Because the hash-based scans performed in accordance with various embodiments are based on blocks, i.e., the entirety of a block, block hashes cannot be used to identify matching portions of blocks. That is, the end of file blocks are typically smaller than the size of an entire block. Thus, the scan hash and cryptographic hash would not match a “full” block with the same data at the start thereof.

Hardware processor 202 may execute instruction 246 to identify instances where actual data of the current build corresponding to the gap matches that of the target build. Hardware processor 202 may execute instruction 248 to append resources associated with the identified instances to a corresponding reusable block. In this way, a block of data (corresponding to a binary resource or merged binary resource) can be “grown” to include this additional data.

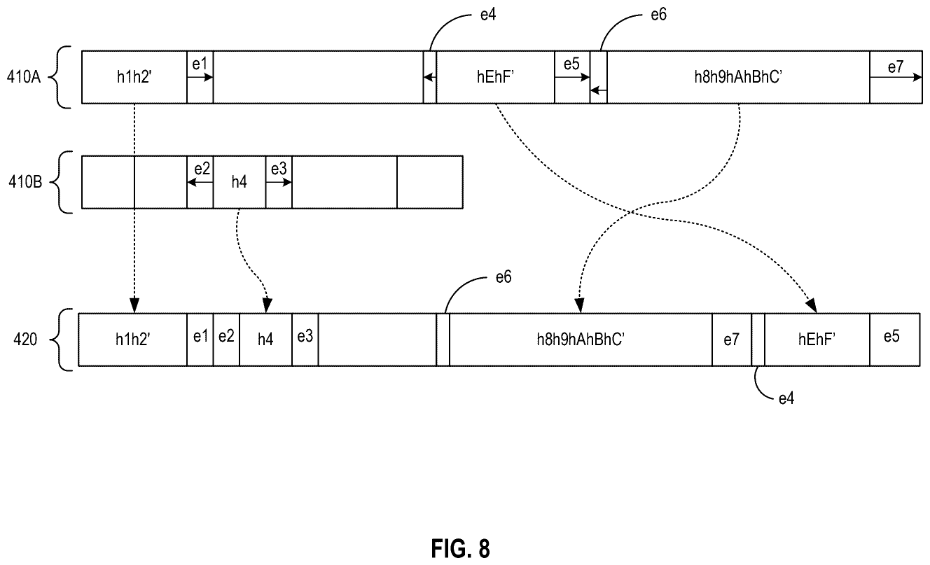

FIG. 8 illustrates an example edge-scanning operation to identify additional target build resources in accordance with various embodiments of the disclosed technology. At a remaining edge of block h1h2′, in accordance with the execution of the instructions set forth in FIG. 7, for example, a gap may be identified, and after a comparison of actual data of the current and target builds, a determination may be made that the gap is associated with a binary resource e1 that may be reused by the target build. Block h1h2′ may be grown by the appending of binary resource e1 thereto. The reusable resource corresponding to the hash value h4 may also be associated with gaps at its edges, where binary resources e2 and e3 may be deemed to be reusable and thus, are appended to the binary resource. It can be appreciated that similarly, data at the edges of block hEhF′ (i.e., binary resources e4 and e5) match that of the target build, and thus, block hEhF′ is grown accordingly. The same holds true of binary resources e6 and e7 relative to block h8h9hAhBhC′. As with “complete” blocks, offsets do not hinder the ability of embodiments of the disclosed technology from identifying block portions, as evidenced by blocks hEhF′ and h8h9hAhBhC′.

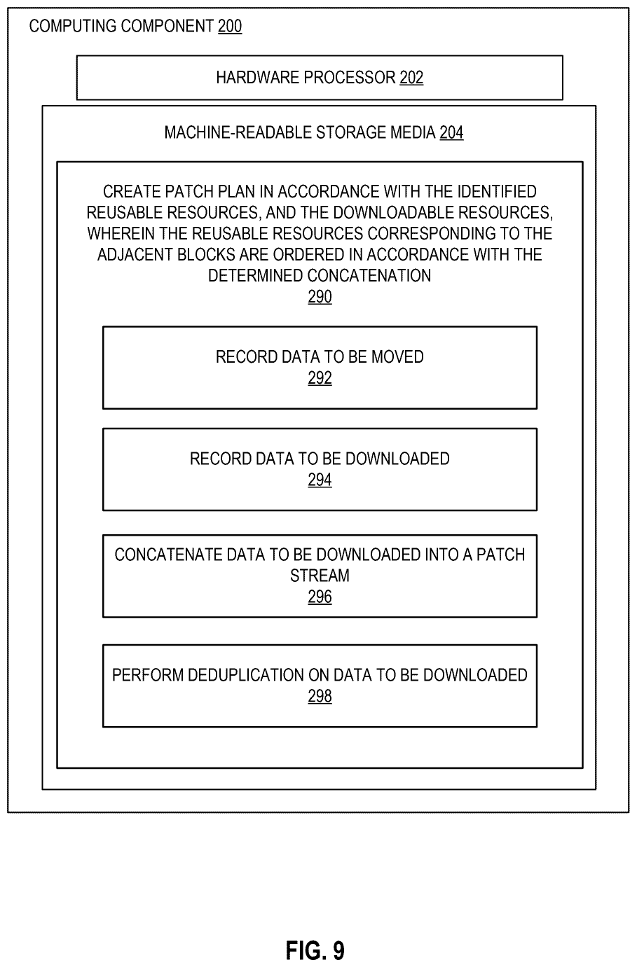

FIG. 9 is an example computing component that may be used to create a patch plan in accordance with an embodiment of the disclosed technology. Computing component 200, hardware processor 202, and machine-readable storage media 204 have been described above.

Hardware processor 202 may execute instruction 292 to record any data or parts of data that need to be moved. Such data may be recorded to or incorporated as part of the patch plan. Hardware processor 202 may execute instruction 294 to record bits to be downloaded. As discussed above, any resources of a target build that cannot be “obtained” from a current build are downloaded, e.g., from the CDN. Such resources can be downloaded by virtue of adding all data copied into a patch stream (or multiple if language streams exist), and adjusting the source location(s) in the patch plan to be pointing to the patch stream. Thus, when a client computing device executes the patch plan, the client computing device will know to download the patch stream (instead of copying a resource(s) from a client computing device).

Hardware processor 202 may further execute instruction 296 to concatenate data to be downloaded into a patch stream. To simplify the downloading of data (corresponding to a binary resource(s)), the data to be downloaded are merged, so that multiple calls to download data can be avoided. Instead, downloading can be effectuated via a single patch stream, similar to the concatenation/merging of adjacent blocks.

Hardware processor 202 may also execute instruction 298 to perform deduplication on data to be downloaded. As discussed above, duplicate downloads may be avoided by only downloading a first instance of a matching block, and using copy operations to copy that downloaded resource/data to other locations of the target file(s).

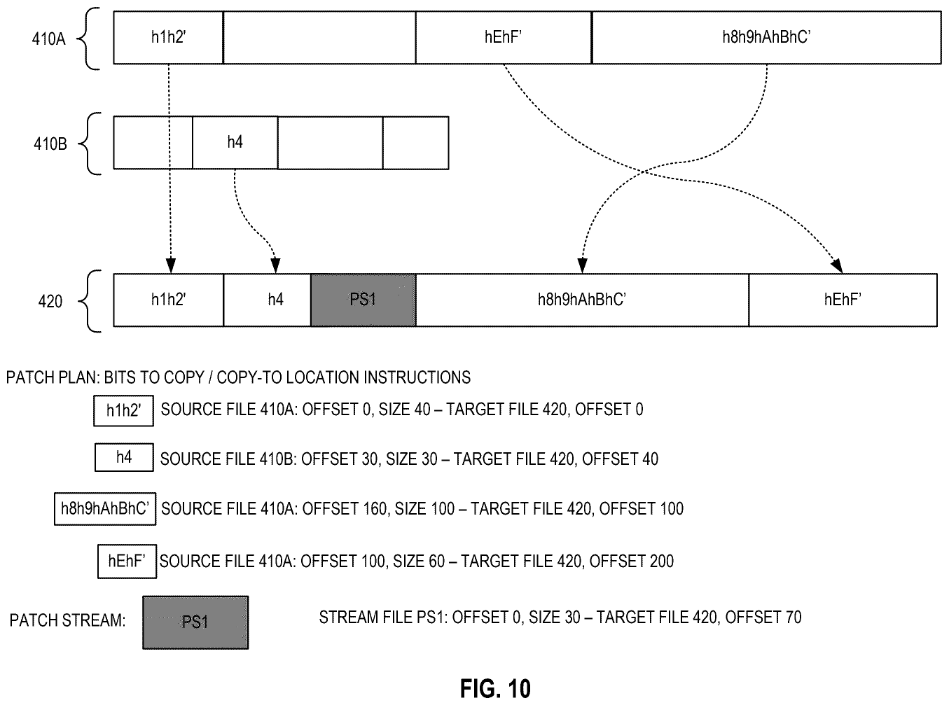

FIG. 10 illustrates an example representation of data/information comprising a patch plan created in accordance with embodiments of the present disclosure. As discussed, a patch plan may comprise instructions/details regarding what binary resource bits are to be copied, along with instructions regarding where to copy the binary resource bits. Again, embodiments of the disclosed technology are directed to determining what resources of a current build may be reused in a target build pursuant to version patching. As also discussed above, adjacent blocks of binary resources may be concatenated to create merged blocks. The relevant metadata regarding such merged blocks, h1h2′, hEhF′, and h8h9hAhBhC′, e.g., the source file from which the resources may be copied, along with information characterizing or defining the merged blocks (offset, size), as well as a target file destination, may be set forth in a patch plan for a client computing device to follow. Similarly, if any bits are to be downloaded (due to a lack of reusable bits from a current build), the bits are concatenated into a patch stream, e.g., PS1, which may also be defined (i.e., associated metadata included) as part of the patch plan or in addition to the patch plan.

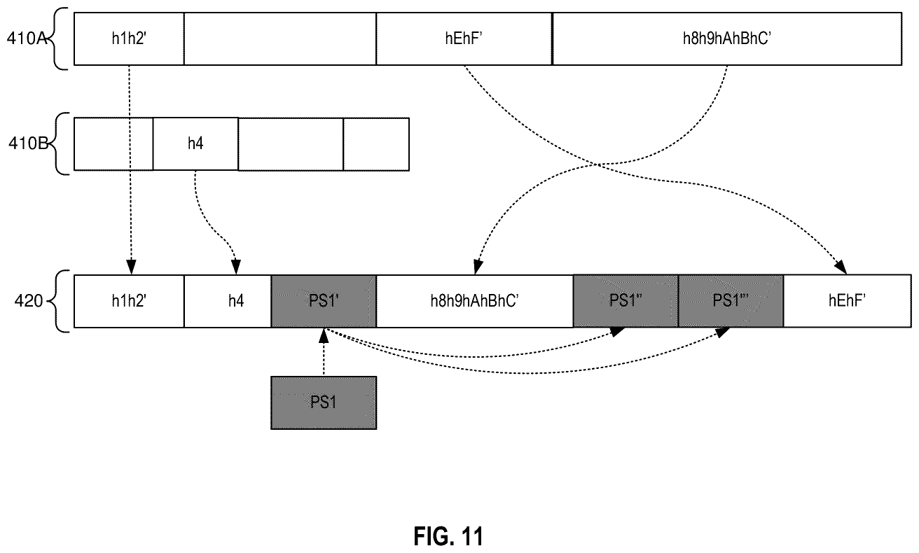

FIG. 11 illustrates an example deduplication/copying operation in accordance with an embodiment of the disclosed technology. As discussed, in accordance with some embodiments, a deduplication operation may be performed in order to reduce the amount of downloads that a client computing device has to perform. That is, if the same data/binary resources are needed in multiple locations at a target file(s), instead of downloading separate instances of the same data/binary resources in accordance with their location in the target file, a single download is performed via the aforementioned patch stream. After downloading the data via the patch stream, that downloaded data may simply be copied to the appropriate locations in the target file. In the example deduplication/copying operation of FIG. 11, it can be appreciated that the client device, following the patch plan, may perform a single download of the data concatenated into patch stream PS1. After the data is downloaded, the data may be copied to the appropriate locations in target file 420, e.g., locations PS1′, PS1″, and PS1′″.

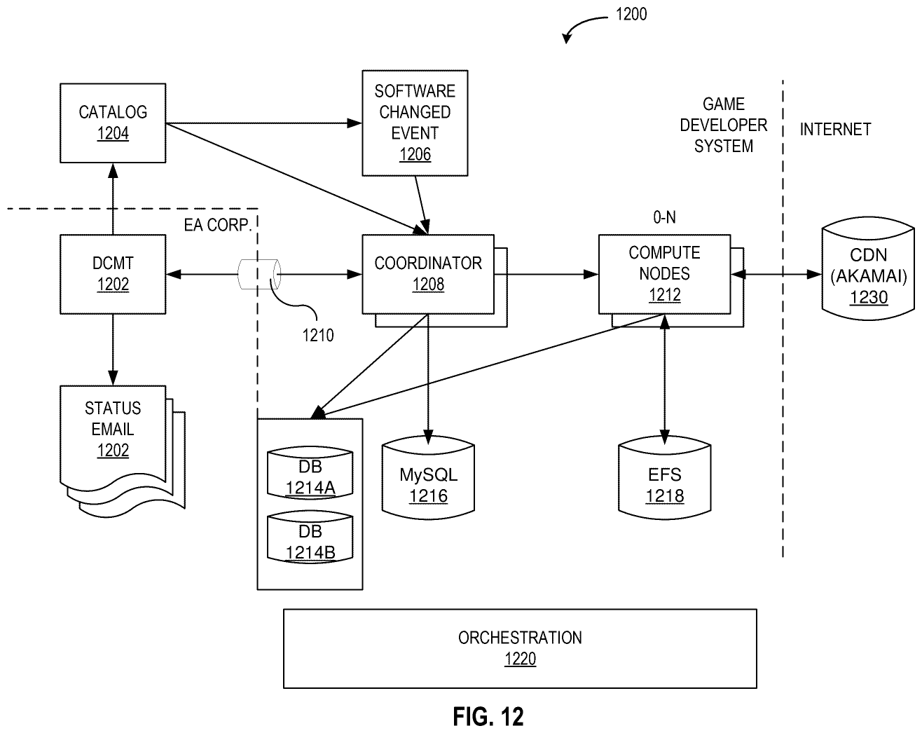

FIG. 12 illustrates an example system architecture 1200 for implementing known version patching in accordance with an embodiment of the disclosed technology. The dotted lines delineate boundaries between an “internal” game developer system (comprising services/functionality directed to game developers and to a game development company internal personnel), an “external game services system (comprising services/functionality directed to users/players of games), and the Internet or other network of which CDN 1230 is a part. When a new game build/version is to be published, the developer/game development team, operating in the EA Corp. portion of system 1200, may publish, via digital content management tool (DCMT) 1202, such a build to CDN 1230, which in some implementations may be a cloud network provided/hosted by Akamai, for example. After publishing the build to CDN 1230, DCMT 1202 may update catalog 1204. Catalog 1204 may store/maintain various information about games provided by the game developer, as well as download uniform resource locators (URLs), and so on. After the game build is updated in catalog 1204, DCMT 1202 may be used to set a date (or date/time) when the new build will be “live,” e.g., available for download. The setting of such a build-live date triggers an event, e.g., a software changed event 1206.

Coordinator 1208, which may coordinate/control the use/operation of known version patching in accordance with embodiments of the disclosed technology, and described herein, listens to/monitors catalog 1204 for the existence of a software changed event 1206. Upon sensing or discovering software changed event 1206, coordinator 1208 may instruct one or more compute nodes 1212 to download the new (published) build, referred to as N, along with an M number of previous builds. For example, as described herein, patch plans can be generated upon preparing a new build. For example, version X may be due for an update to version N, version X-1 may be due for an update to Version N, version x-2 may be due for an update to version N, etc. In some embodiments a “back” patch may be generated in the case there is a need to regress in build version, e.g., from version N back to version X (the current build). It should be noted that patch plans, and patch streams that are generated may be uploaded to CDN 1230 as additional data. In this way, when a client device requests data to update a current build/version to a new/target build or version of software, a URL corresponding to an appropriate patch plan can be provided, together with any relevant patch streams.

A tunnel 1210 supports communications/connections between coordinator 1208 and DCMT 1202. In some embodiments, tunnel 1210 comprises a REST application programming interface (API) connection to notify DCMT 1202 of changes in the status of a patch generation. This can be used to trigger, e.g., emails, to interested parties/entities regarding the state of deployment of a patch. In some embodiments, coordinator 1208 uses a MySQL server 1216 for tracking build states for patches that have been initiated by coordinator 1208. Build state data may be maintained in databases 1214A/B, for example. Databases 1214A/B can be hosted in a remote desktop services (RDS) host (not shown), such as a server (physical or virtual). Elastic file system (EFS) component 1218 can be used by compute nodes 1212 for serverless file storage/file sharing. Orchestration component 1220 may control or effectuate timing/scheduling/scaling/deployment/etc. of coordinator 1208 and/or other elements or aspects of the game developer system side of system 1200, i.e., the known version patching infrastructure. Orchestration can be effectuated using an orchestration system/method, such as Kubernetes using, in some embodiments, a yard master template.

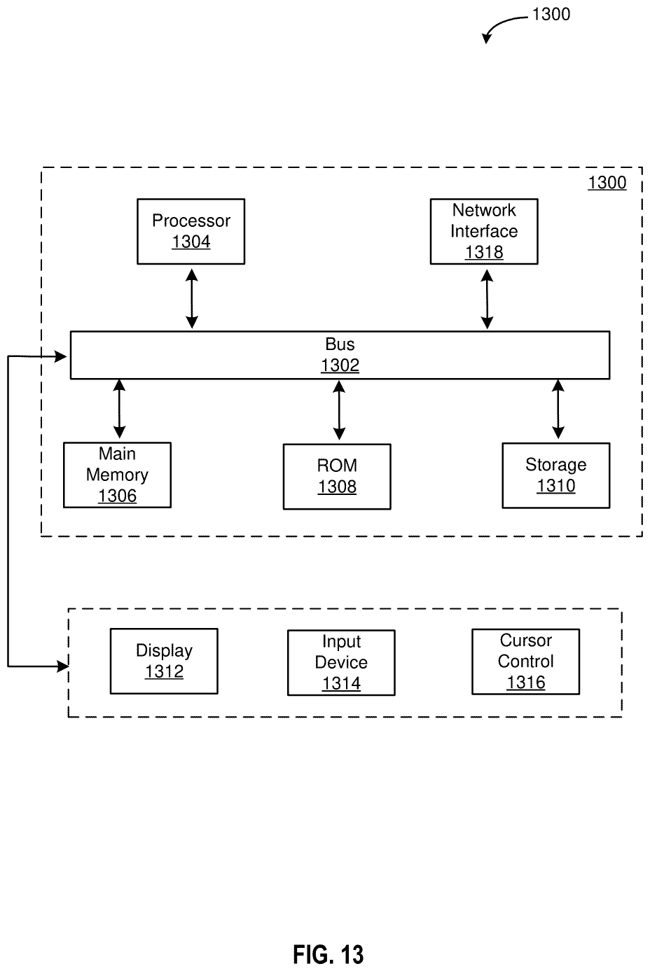

FIG. 13 depicts a block diagram of an example computer system 1300 in which various of the embodiments described herein may be implemented. The computer system 1300 includes a bus 1302 or other communication mechanism for communicating information, one or more hardware processors 1304 coupled with bus 1302 for processing information. Hardware processor(s) 1304 may be, for example, one or more general purpose microprocessors.

The computer system 1300 also includes a main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. Such instructions, when stored in storage media accessible to processor 1304, render computer system 1300 into a special-purpose machine that is customized to perform the operations specified in the instructions.

The computer system 1300 further includes a read only memory (ROM) 1308 or other static storage device coupled to bus 1302 for storing static information and instructions for processor 1304. A storage device 1310, such as a magnetic disk, optical disk, or USB thumb drive (Flash drive), etc., is provided and coupled to bus 1302 for storing information and instructions.

The computer system 1300 may be coupled via bus 1302 to a display 1312, such as a liquid crystal display (LCD) (or touch screen), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. In some embodiments, the same direction information and command selections as cursor control may be implemented via receiving touches on a touch screen without a cursor.

The computing system 1300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor(s) 1304 executing one or more sequences of one or more instructions contained in main memory 1306. Such instructions may be read into main memory 1306 from another storage medium, such as storage device 1310. Execution of the sequences of instructions contained in main memory 1306 causes processor(s) 1304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1310. Volatile media includes dynamic memory, such as main memory 1306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1302. Transmission media can also take the form of acoustic or light waves, such as those generated during radio-wave and infra-red data communications.

The computer system 1300 also includes a communication interface 1318 coupled to bus 1302. Network interface 1318 provides a two-way data communication coupling to one or more network links that are connected to one or more local networks. For example, communication interface 1318 may be an integrated services digital network (ISDN) card, cable modem, satellite modem, or a modem to provide a data communication connection to a corresponding type of telephone line. As another example, network interface 1318 may be a local area network (LAN) card to provide a data communication connection to a compatible LAN (or WAN component to communicated with a WAN). Wireless links may also be implemented. In any such implementation, network interface 1318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1318, which carry the digital data to and from computer system 1300, are example forms of transmission media.

The computer system 1300 can send messages and receive data, including program code, through the network(s), network link and communication interface 1318. In the Internet example, a server might transmit a requested code for an application program through the Internet, the ISP, the local network and the communication interface 1318.

The received code may be executed by processor 1304 as it is received, and/or stored in storage device 1310, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1300.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a processor; and
a memory-readable storage medium storing instructions, that when executed, cause the processor to:
identify reusable resources of a current software build for a target software build;
concatenate adjacent blocks representative of the identified reusable resources for use in the target software build;
identify additional resources for the target software build based on edges of the identified reusable resources;
identify downloadable resources for the target software build; and
create a patch plan in accordance with the identified reusable resources, and the downloadable resources.

2. The system of claim 1, wherein the instructions that cause the processor to identify reusable resources comprise further instructions that when executed, cause the processor to generate target software build artifacts.

3. The system of claim 2, wherein the target software build artifacts comprise target software build file metadata and instructions to scan the target software build in accordance with a determined block size.

4. The system of claim 1, wherein the instructions that cause the processor to identify reusable resources comprise further instructions that when executed, cause the processor to calculate hash values for blocks of the target software build.

5. The system of claim 4, wherein the calculated hash values comprise scan hash values to achieve an initial identification of reusable resources, and cryptographic hash values to validate the initial identification of the reusable resources.

6. The system of claim 1, wherein the instructions that cause the processor to identify reusable resources comprise further instructions that when executed, cause the processor to perform a scan of the current software build in accordance with a determined block size.

7. The system of claim 6, wherein the instructions that cause the processor to identify reusable resources comprise further instructions that when executed, cause the processor to identify those blocks of the current software build with that of blocks of the target software build.

8. The system of claim 1, wherein the instructions that cause the processor to concatenate adjacent blocks representative of the identified reusable resources comprises further instructions that when executed, cause the processor to determine locations of the identified blocks in response to identifying those blocks of the current software build with a scan hash value that matches that of blocks of the target software build.

9. The system of claim 8, wherein the instructions that cause the processor to concatenate adjacent blocks representative of the identified reusable resources comprises further instructions that when executed, cause the processor to determine adjacency of the identified blocks.

10. The system of claim 9, wherein the instructions that cause the processor to determine adjacency of the identified blocks comprises further instructions that when executed, cause the processor to determine offsets corresponding to the identified blocks and sizes of blocks.

11. The system of claim 10, wherein the instructions that cause the processor to determine adjacency of the identified blocks comprises further instructions that when executed, cause the processor to record the locations of the identified blocks in a copy operation array, wherein the adjacent identified blocks are to be copied in a single copy operation.

12. The system of claim 10, wherein the instructions that cause the processor to identify additional resources for the target build comprises further instructions that when executed, cause the processor to determine if a gap indicative of a portion of a build without a reusable resource exists at each edge of a reusable block.

13. The system of claim 12, wherein the instructions that cause the processor to identify additional resources for the target build comprises further instructions that when executed, cause the processor to compare actual data of the current software build at the gap with actual data of the target software build.

14. The system of claim 13, wherein the instructions that cause the processor to identify additional resources for the target build comprises further instructions that when executed, cause the processor to identify instances where the actual data of the current software build that corresponds to the gap matches that of the target software build.

15. The system of claim 14, wherein the instructions that cause the processor to identify additional resources for the target build comprises further instructions that when executed, cause the processor to append resources associated with the identified instances to a corresponding reusable block.

16. The system of claim 1, wherein the instructions that cause the processor create the patch plan comprises further instructions that when executed, cause the processor to concatenate bits representative of the downloadable resources to be downloaded into a patch stream pursuant to a deduplication operation.

17. A version patching server, comprising:
a processor; and
a memory comprising instructions that when executed cause the processor to:
monitor a game development system for a software changed event associated with a new software build for upgrading a current software build, the new software build having been generated via block scanning, in accordance with a defined block size, of the new software build and the current software build at the version patching server, and identifying reusable resources from the current software build;
in response to discovering a software changed event, instructing a client computing device to download the new software build and a corresponding patch plan providing instructions regarding how the client computing device is to recreate the new software build based on an instance of the current software build resident on the client computing device.

18. The version patching server of claim 17, wherein the defined block size comprises a configurable patching parameter selected to optimize the identification of the reusable resources.

19. The version patching server of claim 17, wherein the current software build comprises a plurality of software files from which the reusable resources are identified, and wherein the plurality of software files need not be named the same as a plurality of software files comprising the new software build.

20. The version patching server of claim 17, wherein the patch plan comprises a patch stream directing the client computing device to a uniform resource locator for accessing a concatenated set of downloadable, un-reusable resources, and wherein the patch plan comprises at least one set of concatenated, reusable resources.
